(19) United States
(12) Patent Application Publication
(10) Pub. No.: US 2019/0349810 A1
(43) Pub. Date: Nov. 14, 2019

(54) METHOD FOR TRANSMITTING LOSSLESS DATA PACKET BASED ON QUALITY OF SERVICE (QOS) FRAMEWORK IN WIRELESS COMMUNICATION SYSTEM AND A DEVICE THEREFOR

(71) Applicant: LG Electronics Inc., Seoul (KR)

(72) Inventors: Heejeong Cho, Seoul (KR); Sunyoung Lee, Seoul (KR); Seungjune Yi, Seoul (KR); Youngdae Lee, Seoul (KR)

(21) Appl. No.: 16/475,442

(22) PCT Filed: Jan. 5, 2018
(86) PCT No.: PCT/KR2018/000237

§ 371 Date: Jul. 2, 2019

Related U.S. Application Data
(60) Provisional application No. 62/442,986, filed on Jan. 6, 2017.
(60) Provisional application No. 62/510,243, filed on May 23, 2017.

(51) Int. Cl. H04W 28/06; H04W 28/02; H04W 80/08; H04L 1/16; H04W 76/27

(52) U.S. Cl. CPC H04W 28/06; H04W 28/0268; H04W 28/0263; H04L 1/1614; H04W 76/27; H04W 80/08

(57) ABSTRACT

The present invention relates to a wireless communication system. More specifically, the present invention relates to a method and a device for transmitting lossless data packet based on QoS framework in wireless communication system, the method comprising: transmitting one or more PDCP SDUs via a first DRB to a receiver; determining whether each of the one or more PDCP SDUs is successfully transmitted or not on the first DRB, when a DRB mapped to a QoS flow is changed from the first DRB to a second DRB; re-transmitting one or more first PDCP SDUs via the first DRB to the receiver; and transmitting one or more second PDCP SDUs via the second DRB to the receiver.

### TECHNICAL FIELD

The present invention relates to a wireless communication system and, more particularly, to a method for transmitting lossless data packet based on QoS framework in wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE OF INVENTION

### Technical Problem

An object of the present invention devised to solve the problem lies in a method and device for transmitting lossless data packet based on QoS framework in wireless communication system.

The technical problems solved by the present invention are not limited to the above technical problems and those skilled in the art may understand other technical problems from the following description.

### Solution to Problem

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects of Invention

In this invention, it is proposed of lossless and selective data forwarding in flow based QoS framework when QoS flow to DRB mapping is changed.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4A is a block diagram illustrating network structure of NG Radio Access Network (NG-RAN) architecture, and FIG. 4B is a block diagram depicting architecture of functional Split between NG-RAN and 5G Core Network (5GC);

FIG. 5 is a diagram showing a control plane and a user plane of a radio interface protocol between a UE and a NG-RAN based on a 3rd generation partnership project (3GPP) radio access network standard;

FIG. 6 is an example for L2 data flow between a UE and a NG-RAN;

FIG. 7 is a diagram for classification and user plane marking for QoS flows and mapping to NG-RAN resources;

FIG. 8a is an example of UL data handling at handover, and FIG. 8b is an example of DL data handling at handover;

FIG. 9 is a conceptual diagram for EPS bearer service architecture in LTE (E-UTRAN) system;

FIG. 10 is a conceptual diagram for 5G QoS model;

FIG. 11 is a conceptual diagram for the relationship between U-plane protocol layers and DRB according to embodiments of the present invention;

FIG. 12 is a conceptual diagram for transmitting lossless data packet based on QoS framework in wireless communication system according to embodiments of the present invention;

FIGS. 13a to 13c are examples for determining a highest COUNT value among COUNT values of the PDCP SDUs which are successfully transmitted on the first DRB based on the received PDCP status report;

FIG. 14 is a conceptual diagram for receiving lossless data packet based on QoS framework in wireless communication system according to embodiments of the present invention;

FIGS. 15 to 17 are examples for transmitting lossless data packet based on QoS framework in wireless communication system according to embodiments of the present invention; and

FIG. 18 is a block diagram of a communication apparatus according to an embodiment of the present invention.

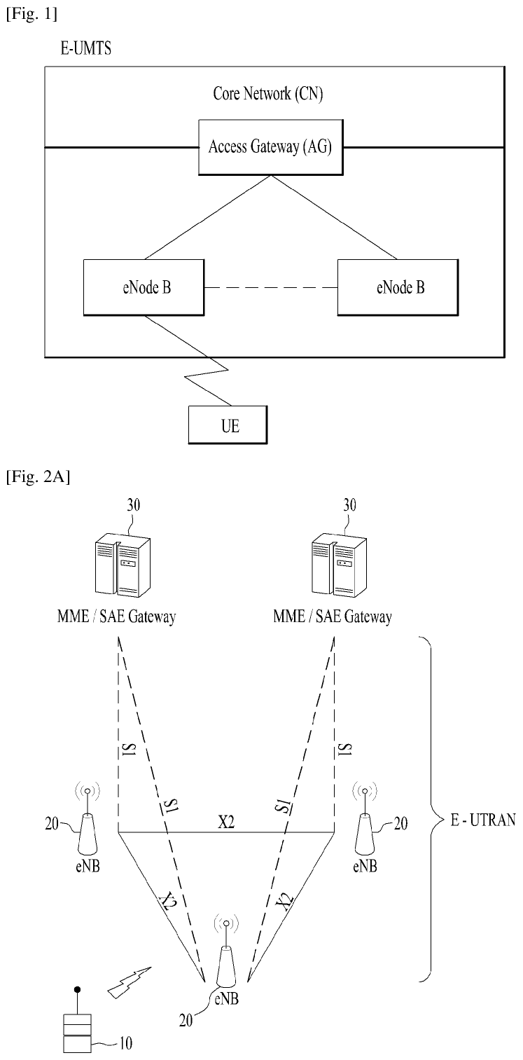

### BEST MODE FOR CARRYING OUT THE INVENTION

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

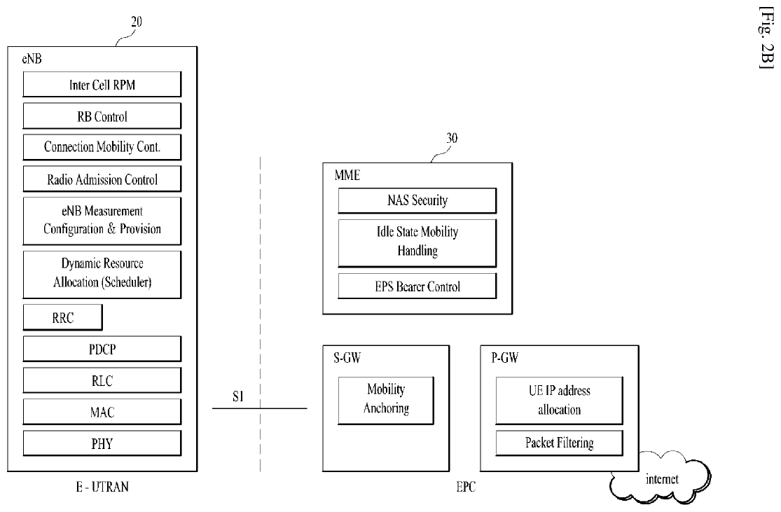

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an Si interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE-ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

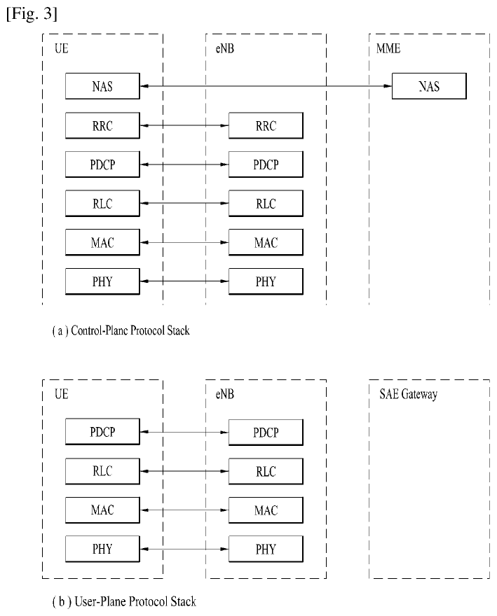

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

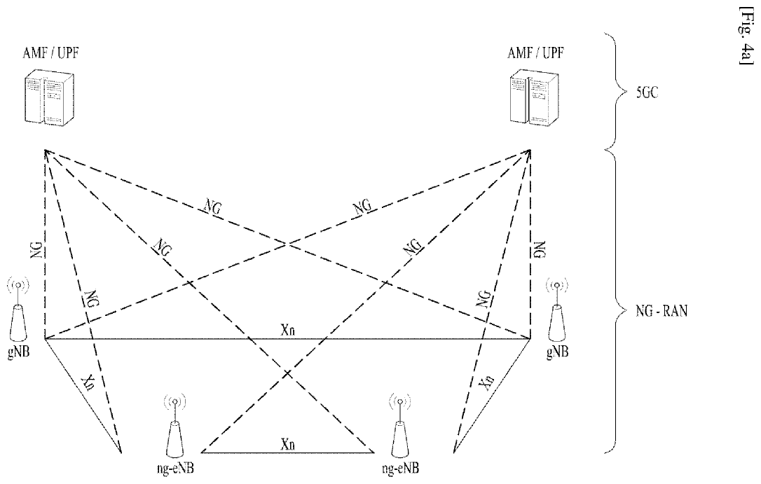

FIG. 4a is a block diagram illustrating network structure of NG Radio Access Network (NG-RAN) architecture, and FIG. 4b is a block diagram depicting architecture of functional Split between NG-RAN and 5G Core Network (5GC).

An NG-RAN node is a gNB, providing NR user plane and control plane protocol terminations towards the UE, or an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the SGC, more specifically to the AMF (Access and Mobility Management Function) by means of the NG-C interface and to the UPF (User Plane Function) by means of the NG-U interface.

The Xn Interface includes Xn user plane (Xn-U), and Xn control plane (Xn-C). The Xn User plane (Xn-U) interface is defined between two NG-RAN nodes. The transport network layer is built on IP transport and GTP-U is used on top of UDP/IP to carry the user plane PDUs. Xn-U provides non-guaranteed delivery of user plane PDUs and supports the following functions: i) Data forwarding, and ii) Flow control. The Xn control plane interface (Xn-C) is defined between two NG-RAN nodes. The transport network layer is built on SCTP on top of IP. The application layer signalling protocol is referred to as XnAP (Xn Application Protocol). The SCTP layer provides the guaranteed delivery of application layer messages. In the transport IP layer point-to-point transmission is used to deliver the signalling PDUs. The Xn-C interface supports the following functions: i) Xn interface management, ii) UE mobility management, including context transfer and RAN paging, and iii) Dual connectivity.

The NG Interface includes NG User Plane (NG-U) and NG Control Plane (NG-C). The NG user plane interface (NG-U) is defined between the NG-RAN node and the UPF. The transport network layer is built on IP transport and GTP-U is used on top of UDP/IP to carry the user plane PDUs between the NG-RAN node and the UPF. NG-U provides non-guaranteed delivery of user plane PDUs between the NG-RAN node and the UPF.

The NG control plane interface (NG-C) is defined between the NG-RAN node and the AMF. The transport network layer is built on IP transport. For the reliable transport of signalling messages, SCTP is added on top of IP. The application layer signalling protocol is referred to as NGAP (NG Application Protocol). The SCTP layer provides guaranteed delivery of application layer messages. In the transport, IP layer point-to-point transmission is used to deliver the signalling PDUs.

NG-C provides the following functions: i) NG interface management, ii) UE context management, iii) UE mobility management, iv) Configuration Transfer, and v) Warning Message Transmission.

The gNB and ng-eNB host the following functions: i) Functions for Radio Resource Management: Radio Bearer Control, Radio Admission Control, Connection Mobility Control, Dynamic allocation of resources to UEs in both uplink and downlink (scheduling), ii) IP header compression, encryption and integrity protection of data, iii) Selection of an AMF at UE attachment when no routing to an AMF can be determined from the information provided by the UE, iv) Routing of User Plane data towards UPF(s), v) Routing of Control Plane information towards AMF, vi) Connection setup and release, vii) Scheduling and transmission of paging messages (originated from the AMF), viii) Scheduling and transmission of system broadcast information (originated from the AMF or O&M), ix) Measurement and measurement reporting configuration for mobility and scheduling, x) Transport level packet marking in the uplink, xi) Session Management, xii) Support of Network Slicing, and xiii) QoS Flow management and mapping to data radio bearers. The Access and Mobility Management Function (AMF) hosts the following main functions: i) NAS signalling termination, ii) NAS signalling security, iii) AS Security control, iv) Inter CN node signalling for mobility between 3GPP access networks, v) Idle mode UE Reachability (including control and execution of paging retransmission), vi) Registration Area management, vii) Support of intra-system and inter-system mobility, viii) Access Authentication, ix) Mobility management control (subscription and policies), x) Support of Network Slicing, and xi) SMF selection.

The User Plane Function (UPF) hosts the following main functions: i) Anchor point for Intra-/Inter-RAT mobility (when applicable), ii) External PDU session point of interconnect to Data Network, iii) Packet inspection and User plane part of Policy rule enforcement, iv) Traffic usage reporting, v) Uplink classifier to support routing traffic flows to a data network, vi) QoS handling for user plane, e.g. packet filtering, gating, UL/DL rate enforcement, and vii) Uplink Traffic verification (SDF to QoS flow mapping).

The Session Management function (SMF) hosts the following main functions: i)

Session Management, ii) UE IP address allocation and management, iii) Selection and control of UP function, iv) Configures traffic steering at UPF to route traffic to proper destination, v) Control part of policy enforcement and QoS, vi) Downlink Data Notification.

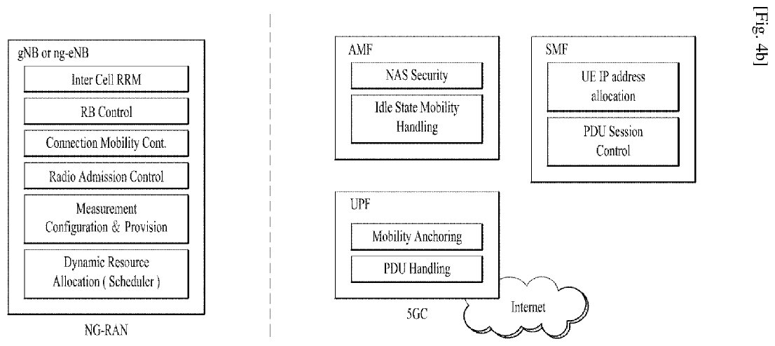

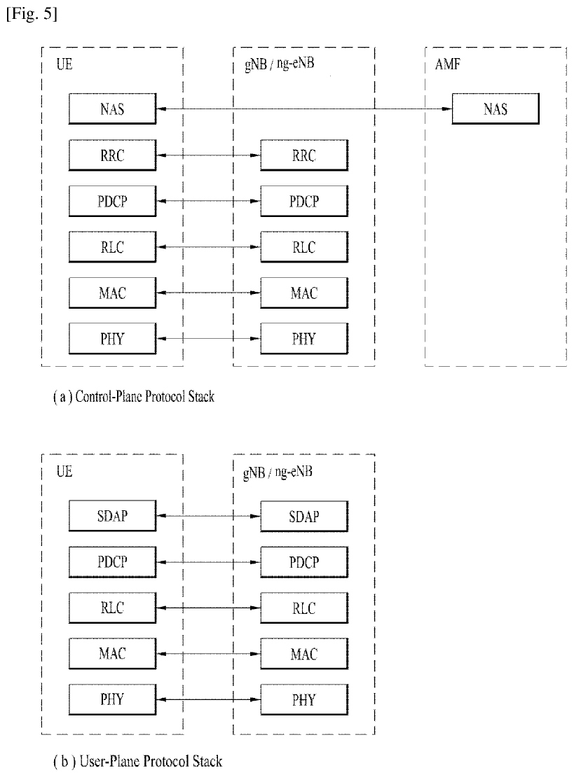

FIG. 5 is a diagram showing a control plane and a user plane of a radio interface protocol between a UE and a NG-RAN based on a 3rd generation partnership project (3GPP) radio access network standard.

The user plane protocol stack contains Phy, MAC, RLC, PDCP and SDAP (Service Data Adaptation Protocol) which is newly introduced to support 5G QoS model.

The main services and functions of SDAP entity include i) Mapping between a QoS flow and a data radio bearer, and ii) Marking QoS flow ID (QFI) in both DL and UL packets. A single protocol entity of SDAP is configured for each individual PDU session.

At the reception of an SDAP SDU from upper layer for a QoS flow, the transmitting SDAP entity may map the SDAP SDU to the default DRB if there is no stored QoS flow to DRB mapping rule for the QoS flow. If there is a stored QoS flow to DRB mapping rule for the QoS flow, the SDAP entity may map the SDAP SDU to the DRB according to the stored QoS flow to DRB mapping rule. And the SDAP entity may construct the SDAP PDU and deliver the constructed SDAP PDU to the lower layers.

FIG. 6 is an example for L2 data flow between a UE and a NG-RAN.

An example of the Layer 2 Data Flow is depicted on FIG. 6, where a transport block is generated by MAC by concatenating two RLC PDUs from RBx and one RLC PDU from RBy. The two RLC PDUs from RBx each corresponds to one IP packet (n and n+1) while the RLC PDU from RBy is a segment of an IP packet (m).

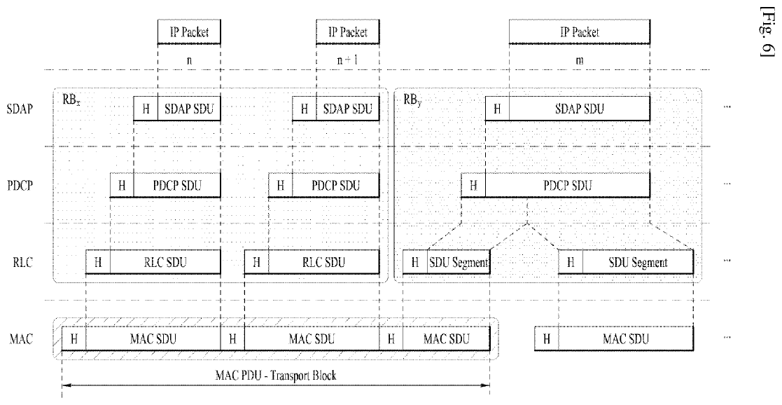

FIG. 7 is a diagram for classification and user plane marking for QoS flows and mapping to NG-RAN resources.

The 5G QoS model is based on QoS flows. The 5G QoS model supports both QoS flows that require guaranteed flow bit rate (GBR QoS flows) and QoS flows that do not require guaranteed flow bit rate (non-GBR QoS flows). The 5G QoS model also supports reflective QoS.

The QoS flow is the finest granularity of QoS differentiation in the PDU session. A QoS Flow ID (QFI) is used to identify a QoS flow in the 5G System. User plane traffic with the same QFI within a PDU Session receives the same traffic forwarding treatment (e.g. scheduling, admission threshold). The QFI is carried in an encapsulation header on N3 (and N9) i.e. without any changes to the e2e packet header. QFI shall be used for all PDU session types. The QFI shall be unique within a PDU session. The QFI may be dynamically assigned or may be equal to the 5QI.

Within the 5G System, a QoS flow is controlled by the SMF and may be preconfigured, or established via the PDU Session Establishment procedure, or the PDU Session Modification procedures.

Any QoS flow is characterized by: i) a QoS profile provided by the SMF to the NG-RAN via the AMF over the N2 reference point or preconfigured in the NG-RAN, ii) one or more QoS rule(s) which can be provided by the SMF to the UE via the AMF over the N1 reference point and/or derived by the UE by applying reflective QoS control, and iii) one or more SDF templates provided by the SMF to the UPF.

The UE performs the classification and marking of UL user plane traffic, i.e. the association of UL traffic to QoS flows, based on QoS rules. These QoS rules may be explicitly provided to the UE (using the PDU Session Establishment/Modification procedure), pre-configured in the UE or implicitly derived by UE by applying reflective QoS.

Reflective QoS enables the UE to map UL user plane traffic to QoS flows by creating UE derived QoS rules in the UE based on the received DL traffic.

A QoS rule contains a QoS rule identifier which is unique within the PDU session, the QFI of the associated QoS flow and a packet filter set for UL and optionally for DL and a precedence value. Additionally, for a dynamically assigned QFI, the QoS rule contains the QoS parameters relevant to the UE (e.g. 5QI, GBR and MBR and the Averaging Window). There can be more than one QoS rule associated with the same QoS Flow (i.e. with the same QFI)

A default QoS rule is required for every PDU Session and associated with the QoS flow of the default QoS rule. The principle for classification and marking of user plane traffic and mapping of QoS flows to NG-RAN resources is illustrated in FIG. 7.

In DL, incoming data packets are classified by the UPF based on SDF templates according to their SDF precedence, (without initiating additional N4 signaling). The UPF conveys the classification of the user plane traffic belonging to a QoS flow through an N3 (and N9) user plane marking using a QFI. The NG-RAN binds QoS flows to NG-RAN resources (i.e. Data Radio Bearers). There is no strict 1:1 relation between QoS flows and NG-RAN resources. It is up to the NG-RAN to establish the necessary NG-RAN resources that QoS flows can be mapped to.

In UL, the UE evaluates UL packets against the packet filter set in the QoS rules based on the precedence value of QoS rules in increasing order until a matching QoS rule (i.e. whose packet filter matches the UL packet) is found. The UE uses the QFI in the corresponding matching QoS rule to bind the UL packet to a QoS flow.

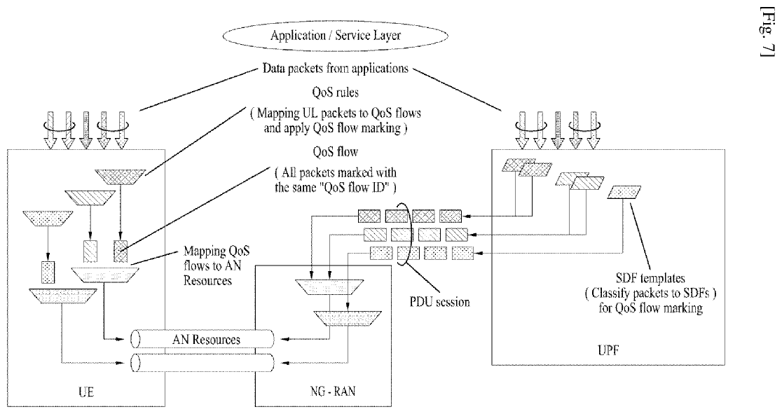

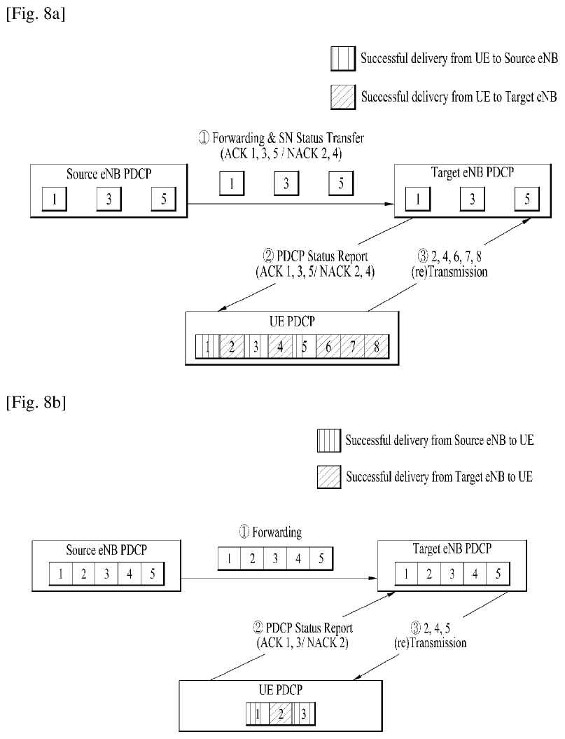

FIG. 8a is an example of UL data handling at handover.

If an UE receives RRC Connection Reconfiguration including the mobility Control Info, the UE re-establishes each PDCP for all RBs (Radio Bearer) that are established. When upper layers request the PDCP re-establishment, the UE performs different procedures per RB depending on the RB's RLC mode such as RLC TM (Transparent Mode), RLC UM (Unacknowledged Mode) and RLC AM (Acknowledged Mode). Especially, procedures for RBs mapped on RLC AM perform some operations for lossless handover, as the followings.

As shown in the FIG. 8a, when a PDCP status report is received in the downlink, for radio bearers that are mapped on RLC AM: for each PDCP SDU, if any, with the bit in the bitmap set to ‘1’, or with the associated COUNT value less than the COUNT value of the PDCP SDU identified by the FMS field, the successful delivery of the corresponding PDCP SDU is confirmed, and the UE shall discard the PDCP SDU (e.g., 1, 3, 5).

From the first PDCP SDU (e.g., 2) for which the successful delivery of the corresponding PDCP PDU has not been confirmed by lower layers, the UE should perform retransmission or transmission of all the PDCP SDUs (e.g., 2, 4, 6, 7, 8) already associated with PDCP SNs in ascending order of the COUNT values associated to the PDCP SDU prior to the PDCP re-establishment

FIG. 8b is an example of DL data handling at handover.

As shown in the FIG. 8b, a PDCP status report may be received in the uplink, for radio bearers that are mapped on RLC AM: for each PDCP SDU, if any, with the bit in the bitmap set to ‘1’, or with the associated COUNT value less than the COUNT value of the PDCP SDU identified by the FMS field, the successful delivery of the corresponding PDCP SDU is confirmed, and the eNB shall discard the PDCP SDU.

From the first PDCP SDU for which the successful delivery of the corresponding PDCP PDU has not been confirmed by lower layers, the eNB should perform retransmission or transmission of all the PDCP SDUs already associated with PDCP SNs in ascending order of the COUNT values associated to the PDCP SDU prior to the PDCP re-establishment.

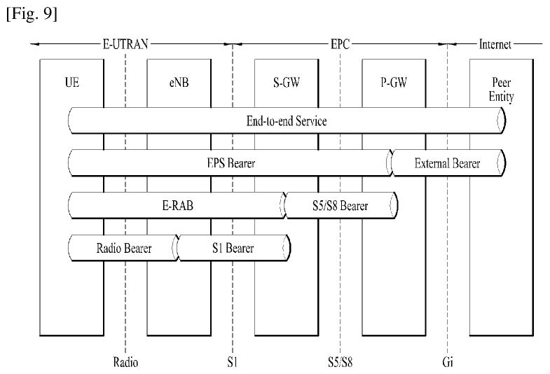

FIG. 9 is a conceptual diagram for EPS bearer service architecture in LTE (E-UTRAN) system.

In the EPC/E-UTRAN, an EPS bearer/E-RAB is the level of granularity for bearer level QoS control and multiple SDFs (Service Data Flow) can be multiplexed onto the same EPS bearer by UE's TFT (Traffic Flow Template) or P-GW's TFT. As shown in the FIG. 9, an E-RAB transports the packets of an EPS bearer between the UE and the EPC. When an E-RAB exists, there is a one-to-one mapping between this E-RAB and an EPS bearer. A data radio bearer transports the packets of an EPS bearer between a UE and one or more eNB(s). When a data radio bearer exists, there is a one-to-one mapping between this data radio bearer and the EPS bearer/E-RAB. Therefore, data flows to RB mapping does not change during the handover.

FIG. 10 is a conceptual diagram for 5G QoS model.

As shown in the FIG. 10, multiple user plane traffics (e.g., IP flow) can be multiplexed onto the same QoS flow and multiple QoS flows can be multiplexed onto the same DRB (Data Radio Bearer). In DL, 5GC is responsible for the IP flow to QoS flow mapping and NG-RAN is responsible for the QoS flow to DRB mapping. In UL, the UE performs a 2-step mapping of IP flows, in which NAS is responsible for the IP flow to QoS flow mapping, and AS is responsible for the QoS flow to DRB mapping. In other words, the UE maps an IP flow to a QoS flow according to the QoS rules such as default QoS rule, pre-authorised QoS rule and/or reflective QoS rule which 5GC provides to the UE. And then, the UE maps the QoS flow to a DRB according to the AS mapping rules which the NG-RAN provides to the UE.

Contrary to EPC/E-UTRAN, QoS flows to DRB mapping can be changed during the handover because AS mapping rule is able to be decided again by target NG-RAN. Therefore this introduces some differences with regard to data forwarding compared to EPC/E-UTRAN, and LTE based lossless data handling based on PDCP SN cannot be directly applied. Cumulative forwarding may need to be applied at (re-)transmission of the QoS flow for which new AS mapping rule should be applied as well as other QoS flows which were multiplexed with the QoS flow onto the same DRB prior to the handover. It can be wasteful retransmission and cause longer packet delay. Thus, new data handling/forwarding mechanism needs to be designed for flow based QoS framework.

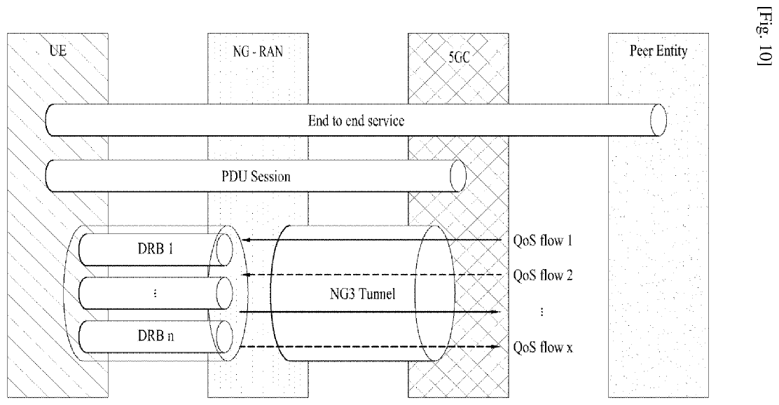

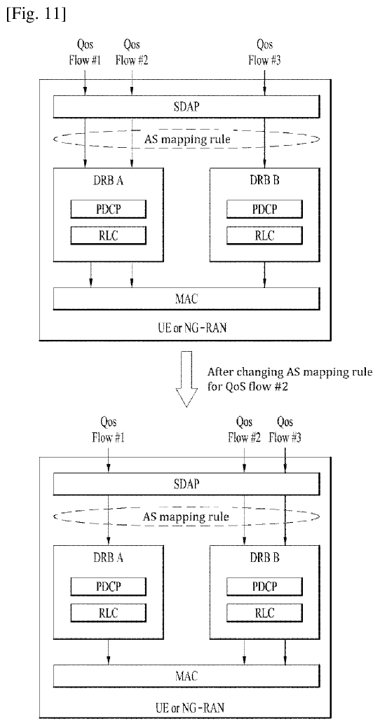

FIG. 11 is a conceptual diagram for the relationship between U-plane protocol layers and DRB according to embodiments of the present invention.

Some terms of this invention are defined as the followings:

PDU session refers to association between the UE and a data network that provides a PDU connectivity service.

PDU connectivity service refers to a service that provides exchange of PDU (Packet Data Units) between a UE and a data network.

QoS rule refers to a set of information enabling the detection of a service data flow (e.g., IP flow) and defining its associated QoS parameters. It consists of NAS-level QoS profile (e.g., QoS characteristics, QoS marking) and packet filters. Three types of QoS rule are Default QoS Rule, Pre-authorised QoS rule and Reflective QoS rule.

Default QoS rule refers to a mandatory QoS rule per PDU Session. It is provided at PDU session establishment to UE.

Pre-authorised QoS rule refers to any QoS rule (different from the Default QoS rule) provided at PDU Session Establishment.

Reflective QoS rule refers to the QoS rule which is created by UE based on QoS rule applied on the DL traffic.

QoS marking refers to a scalar that is used as a reference to a specific packet forwarding behaviour

Packet filter refers to information for matching service data flows. The format of the packet filters is a pattern for matching the IP 5 tuple (source IP address or IPv6 network prefix, destination IP address or IPv6 network prefix, source port number, destination port number, protocol ID of the protocol above IP). Service data flows are mapped to a QoS flow according to DL/UL packet filter.

QoS flow refers to finest granularity for QoS treatment.

NG (Next Generation) system consists of AMF (Access and Mobility Management

Function), SMF (Session Management Function) and UPF (User plane Function).

AS mapping rule refers to a set of information related to the association between

QoS flow and the Data Radio Bearer (DRB) transporting that QoS flow.

AS level reflective QoS refers to updating the UL AS level mapping rule in the UE based on the DL packet with QoS flow ID received within a DRB.

PDU refers to Packet Data Unit.

SDU refers to Service Data Unit.

Service Data Adaptation Protocol (SDAP) refers to a user plane AS protocol layer for the 5G QoS model. SDAP can be named as PDAP.

PDCP status report is used to convey FMC and Bitmap information indicating which PDCP SDUs need to be retransmitted.

FMC (First Missing Count) indicates PDCP COUNT of the first missing PDCP SDU.

Bitmap indicates whether or not the PDCP SDU with the PDCP COUNT (FMC+bit position) has been received. For example, if the first bit's value in the Bitmap field is ‘0’, it indicates that the PDCP SDU with the PDCP COUNT (FMC+1) is missing in the PDCP receiver. If the first bit's value is ‘1’, it indicates that the PDCP SDU with the PDCP COUNT (FMC+1) does NOT need to be retransmitted.

PDCP COUNT is composed of HFN (Hyper Frame Number) and PDCP SN (Sequence Number).

Also, as shown in FIG.11, the present invention is based on a scenario in which the AS mapping rule for QoS flow # 2 is changed from DRB A to DRB B.

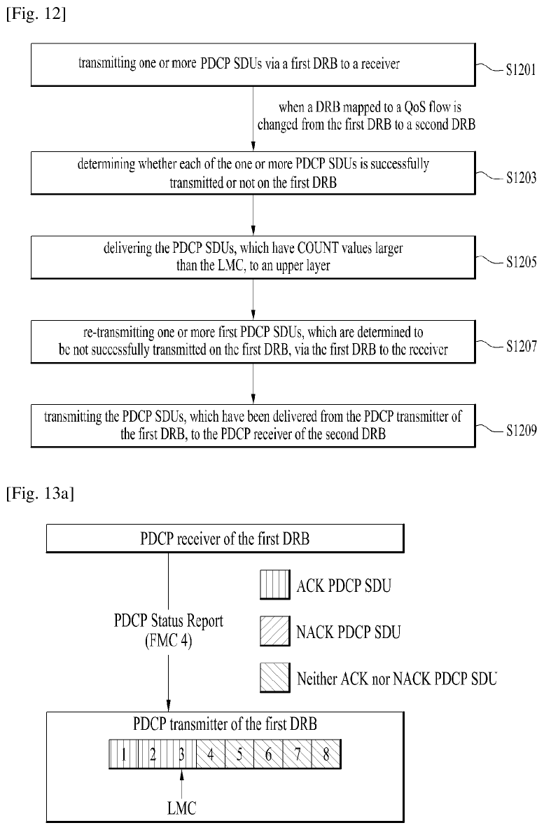

FIG. 12 is a conceptual diagram for transmitting lossless data packet based on QoS framework in wireless communication system according to embodiments of the present invention.

The PDCP transmitter of the first DRB transmits PDCP SDUs to the PDCP receiver of the first DRB before the AS mapping rule is changed (S1201).

For a QoS flow whose AS mapping rule is changed from a first DRB to a second DRB, the PDCP transmitter determines whether each of the one or more PDCP SDUs is successfully transmitted or not on the first DRB (S1203).

Preferably, when the PDCP transmitter of the first DRB receives from the PDCP receiver of the first DRB a PDCP Status Report indicating which PDCP SDUs need to be retransmitted or indicating one or more PDCP SDUs are successfully transmitted or not on the first DRB, the PDCP transmitter determines whether each of the one or more PDCP SDUs is successfully transmitted or not on the first DRB based on the PDCP status report.

Preferably, the PDCP status report can be carried via either a PDCP control PDU or an RRC message. If it is carried via the RRC message, a DRB ID field, which indicates that DRB is subject to the FMC and Bitmap fields in the PDCP status report, is included in the RRC message.

Preferably, the PDCP status report can be received in one or more situations including handover, dual connectivity is configured, or lossless transmission for the QoS flow is supported.

During the above situations, the following information elements should be shared between the source NG-RAN and target NG-RAN and between the UE and target NG-RAN, before the data transfer procedure described below:

Source NG-RAN's QoS flow to DRB mapping information (e.g., QoS flow list mapped on each DRB) is sent by source NG-RAN to target NG-RAN, and target NG-RAN's QoS flow to DRB mapping information, configuration of the existing DRBs (if target NG-RAN wants to modify existing DRBs), configuration of the new DRBs (if target NG-RAN wants to add new DRBs) are transmitted by the target NG-RAN to the UE.

These elements can be sent via interface between NG-RANs and can be forwarded by source NG-RAN to the UE during the preparation for the situations.

There are several methods for determining a highest COUNT value among COUNT values of the PDCP SDUs which are successfully transmitted on the first DRB based on the received PDCP status report. The details are explained below.

Preferably, the highest COUNT value among COUNT values of the PDCP SDUs which are successfully transmitted on the first DRB is the COUNT value of the last PDCP SDU that has been successfully transmitted to the PDCP receiver of the first DRB based on the received PDCP Status Report.

Preferably, the highest COUNT value or the COUNT of the last PDCP SDU is called LMC (Last Mapping Count) in this invention.

The PDCP transmitter of the first DRB delivers the PDCP SDUs, which have COUNT values larger than the LMC, to an upper layer (S1205).

The PDCP transmitter of the first DRB sets Next-PDCP-TX-SN and TX-HFN according to the LMC value, as the followings:

[Definition]

Next-PDCP-TX-SN=PDCP SN in LMC value+1;

TX-HFN=HFN in LMC value.

If there are any PDCP SDUs having COUNT values larger than the LMC, the PDCP transmitter of the first DRB delivers these PDCP SDUs, which have COUNT values higher than a highest COUNT value among COUNT values of the PDCP SDUs which are successfully transmitted on the first DRB, in ascending order of the associated COUNT value to an upper layer (e.g., SDAP layer) so that the PDCP SDUs for the QoS flow of these PDCP SDUs can be forwarded to the PDCP transmitter of the second DRB. If there is no PDCP SDU to be delivered, the PDCP transmitter of the first DRB notifies the SDAP of the fact.

Preferably, the SDAP submits each SDAP PDU for the QoS flow of the SDAP PDUs, which have been delivered from the PDCP transmitter of the first DRB, to the PDCP transmitter of the second DRB. For the other QoS flow(s) whose AS-level mapping rule is not changed, the SDAP submits each SDAP PDU to the PDCP transmitter of the first DRB. After completing the submission of all the delivered SDAP PDUs, the SDAP submits the newly processed SDAP PDUs to the PDCP transmitter of the first or second DRB depending on the AS mapping rule.

Preferably, the PDCP transmitter of the first DRB can discard the delivered PDCP SDUs.

The PDCP transmitter of the first DRB performs retransmission of the NACK PDCP SDUs, which are determined to be not successfully transmitted on the first DRB, in ascending order of the COUNT values associated to the PDCP SDUs via the first DRB to the receiver (S1207).

The PDCP transmitter of the second DRB transmits the PDCP SDUs, which have been delivered from the PDCP transmitter of the first DRB, to the PDCP receiver of the second DRB (S1209).

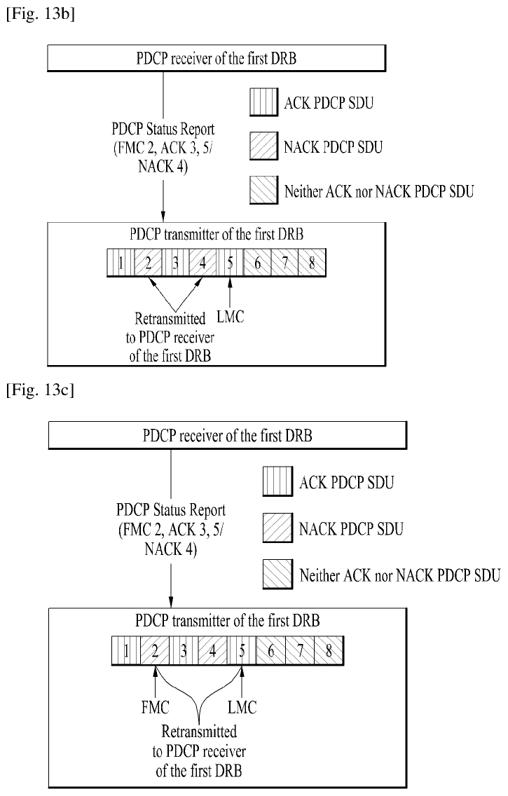

FIGS. 13a to 13c are examples for determining a highest COUNT value among

COUNT values of the PDCP SDUs which are successfully transmitted on the first DRB based on the received PDCP status report. In these examples all PDCP SDUs of the first DRB are user traffic for the QoS flow whose AS mapping rule is changed from DRB A to DRB B.

There are several methods for determining a highest COUNT value among COUNT values of the PDCP SDUs which are successfully transmitted on the first DRB based on the received PDCP Status Report. The highest COUNT value among COUNT values of the PDCP SDUs which are successfully transmitted on the first DRB is the COUNT value of the last PDCP SDU that has been successfully transmitted to the PDCP receiver of the first DRB based on the received PDCP status report. The COUNT of the last PDCP SDU is called LMC (Last Mapping Count) in this invention.

When the Bitmap field is not included in the PDCP status report (case 1, as shown in FIG. 13a),the PDCP transmitter of the first DRB confirms the successful delivery of the PDCP SDUs with the associated COUNT value less than the COUNT value of the PDCP SDU identified by the FMC field (e.g., 4) in the PDCP status report.

Because it means a positive acknowledgement (ACK) of these PDCP SDUs (e.g., 1, 2 and 3), the PDCP transmitter of the first DRB determines any PDCP SDUs don't need to be retransmitted to the PDCP receiver of the first DRB. The PDCP transmitter of the first DRB defines the highest COUNT value as the largest COUNT value (e.g., 3) of these ACK PDCP SDUs.

The PDCP transmitter of the first DRB discards these ACK PDCP SDUs (e.g., 1, 2 and 3), and delivers any PDCP SDUs having COUNT values larger than the LMC (e.g., 3) to the PDCP transmitter of the second DRB. The PDCP transmitter of the second DRB transmits these PDCP SDUs (e.g., in CASE #1: 4, 5, 6, 7 and 8) which have COUNT values higher than the highest COUNT value (e.g., 3) among COUNT values of the PDCP SDUs which are successfully transmitted on the first DRB via the second DRB to the receiver.

When the Bitmap field is included in the PDCP status report (case 2 as shown in FIG. 13b), the PDCP transmitter of the first DRB confirms the successful delivery of the PDCP SDUs with the associated COUNT value less than the COUNT value of the PDCP SDU identified by the FMC field in the PDCP status report. Also, the PDCP transmitter of the first DRB confirms the successful delivery of the PDCP SDUs with the bit in the Bitmap field set to ‘1’. It means a positive acknowledgement (ACK) of these PDCP SDUs (e.g., 1, 3 and 5).

The PDCP transmitter of the first DRB confirms the unsuccessful delivery of the PDCP SDUs with the bit in the Bitmap field set to ‘0’ or identified by the FMC field. It means a negative acknowledgement (NACK) of these PDCP SDUs (e.g., 2 and 4).

The PDCP transmitter of the first DRB defines the highest COUNT value as the largest COUNT value (e.g., 5) of these ACK PDCP SDUs. And the PDCP transmitter of the first DRB determines NACK PDCP SDUs (e.g., 2 and 4) which are determined to be not successfully transmitted on the first DRB, and the PDCP transmitter of the second DRB transmits these PDCP SDUs (e.g., in CASE #2: 6, 7 and 8) which have COUNT values higher than the highest COUNT value (e.g., 5) among COUNT values of the PDCP SDUs which are successfully transmitted on the first DRB via the second DRB to the receiver.

When the Bitmap field is included in the PDCP status report (case 3 as shown in FIG. 13c), the PDCP transmitter of the first DRB confirms the successful delivery of the PDCP SDUs with the associated COUNT value less than the COUNT value of the PDCP SDU identified by the FMC field in the PDCP status report. Also, the PDCP transmitter of the first DRB confirms the successful delivery of the PDCP SDUs with the bit in the Bitmap field set to ‘1’. It means a positive acknowledgement (ACK) of these PDCP SDUs (e.g., 1, 3 and 5).

The PDCP transmitter of the first DRB confirms the unsuccessful delivery of the

PDCP SDUs with the bit in the Bitmap field set to ‘0’ or identified by the FMC field. It means a negative acknowledgement (NACK) of these PDCP SDUs (e.g., 2 and 4).

The PDCP transmitter of the first DRB defines the highest COUNT value as the largest COUNT value (e.g., 5) of these ACK PDCP SDUs. And the PDCP transmitter of the first DRB determines SDUs from the first missing SDU up to the last out-of-sequence SDU indicating in the PDCP status report (e.g.,2-5), and the PDCP transmitter of the second DRB transmits these PDCP SDUs (e.g., in CASE #3: 6, 7 and 8) which have COUNT values higher than the highest COUNT value (e.g., 5) among COUNT values of the PDCP SDUs which are successfully transmitted on the first DRB via the second DRB to the receiver.

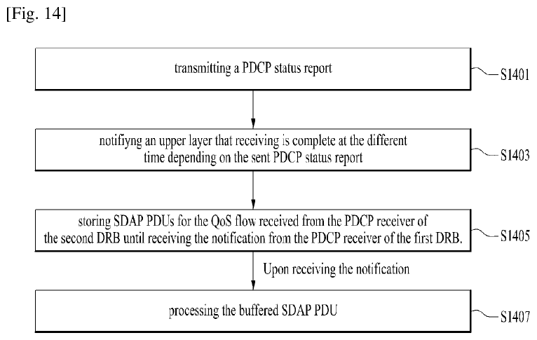

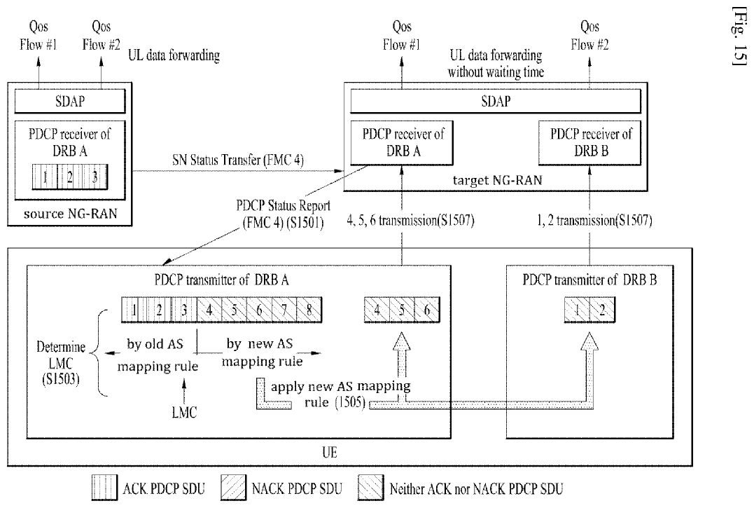

FIG. 14 is a conceptual diagram for receiving lossless data packet based on QoS framework in wireless communication system according to embodiments of the present invention.

The PDCP receiver of the first DRB transmits a PDCP status report (S1401).

Preferably, the PDCP status report can be sent via a PDCP control PDU or an RRC message in one and more situations: i) during the handover, it can be transmitted by a source NG-RAN or a target NG-RAN, ii) while dual connectivity is configured, it can be transmitted by a master NG-RAN or a secondary NG-RAN, or iii) lossless transmission for the QoS flow is supported.

Preferably, if the PDCP status report is transmitted through the RRC message (e.g., RRC Connection Reconfiguration with mobility control information), the RRC message includes the FMC, Bitmap and DRB ID indicating that DRB is subject to the FMC and Bitmap fields.

The PDCP receiver of the first DRB notifies an upper layer (e.g., SDAP layer) that receiving is complete at the different time depending on the sent PDCP status report (S1403).

Preferably, if the Bitmap field is not included in the PDCP status report, the PDCP receiver of the first DRB notifies the SDAP that receiving is complete upon sending the PDCP status report.

Preferably, if the Bitmap field is included in the PDCP status report, the PDCP receiver of the first DRB defines LMC as the largest COUNT value of the ACK PDCP SDUs, and then notifies the SDAP that receiving is complete when all PDCP SDUs from the FMC up to LMC are received and are delivered to the SDAP.

The SDAP buffers SDAP PDUs for the QoS flow received from the PDCP receiver of the second DRB until receiving the notification from the PDCP receiver of the first DRB (S1405). Upon receiving the notification, the SDAP processes the buffered SDAP PDU(s). In other words, the SDAP starts delivering/forwarding the SDAP SDU(s) to upper layer or 5GC (S1407).

If there is no QoS flow mapping on the first DRB after successful delivery of all PDCP SDUs, the first DRB may need to be released.

One option is a timer based release. When a timer, which starts after the successful delivery of one or more PDCP SDUs via a first DRB, is expired, the UE and target NG-RAN release the first DRB without any signaling. Timer value can be pre-defined or configured by target NG-RAN during the handover preparation or the handover execution or after the handover complete, or when dual connectivity is configured.

Another option is a message based release. The UE can request release of the first DRB after the successful delivery of one or more PDCP SDUs via the first DRB and target NG-RAN may send response corresponding to the request. The UE can release the first DRB when response corresponding to the request is received from the NG-RAN.

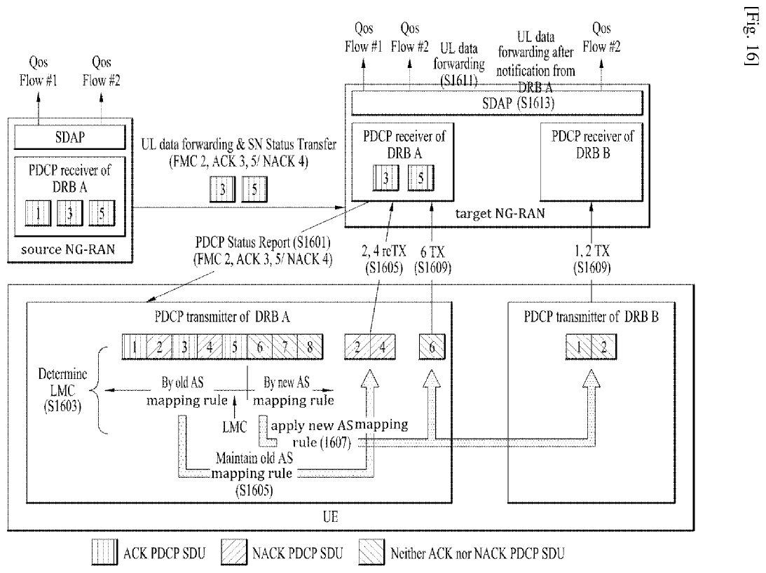

FIG. 15 is an example for transmitting lossless data packet based on QoS framework in wireless communication system according to embodiments of the present invention.

The FIG. 15 illustrates lossless transmission of UL data for QoS flow #2 whose AS mapping rule is changed from DRB A to DRB B during the handover.

Both QoS flow #1 and QoS flow #2 were mapped to DRB A before the handover (named as old AS mapping rule in this invention), but QoS flow #1 is still mapped to DRB A and QoS flow #2 is mapped to DRB B after the handover (named as new AS mapping rule in this invention).

As shown in FIG. 15, when the Bitmap field is not included in the PDCP status report (CASE #1), both UE and target NG-RAN use the PDCP status report in order to support lossless handover, as the followings:

The UE receives the PDCP status report from target NG-RAN (S1501).

The UE considers that the successful delivery of the PDCP SDUs (e.g., 1, 2 and 3), with the associated COUNT value less than the COUNT value of the PDCP SDU identified by the FMC field has been confirmed. The UE defines LMC as the largest COUNT value (e.g., 3) of these ACK PDCP SDUs (S1503).

The UE remaps the PDCP SDUs (e.g., 4˜8), which have COUNT values larger than the LMC, to the DRB decided by the new AS mapping rule. In other words, the PDCP SDU 4, 5 and 7 for the QoS flow #1 are remapped to the DRB A, whereas the PDCP SDU 6 and 8 for the QoS flow #2 are remapped to the DRB B.

The UE associates new PDCP COUNTs with these PDCP SDUs (e.g., in case of DRB A, PDCP SDU 4, 5 and 7->PDCP SDU 4, 5 and 6, and in case of DRB B, PDCP SDU 6 and 8->PDCP SDU 1 and 2) (S1505).

The UE performs transmission of the PDCP SDUs with the newly associated COUNT value (S1507).

When receiving UL data for QoS flow #2 via DRB B, the target NG-RAN forwards the UL data without any waiting time because PDCP receiver of DRB A notifies that receiving for QoS flow #2 is complete upon sending the PDCP status report.

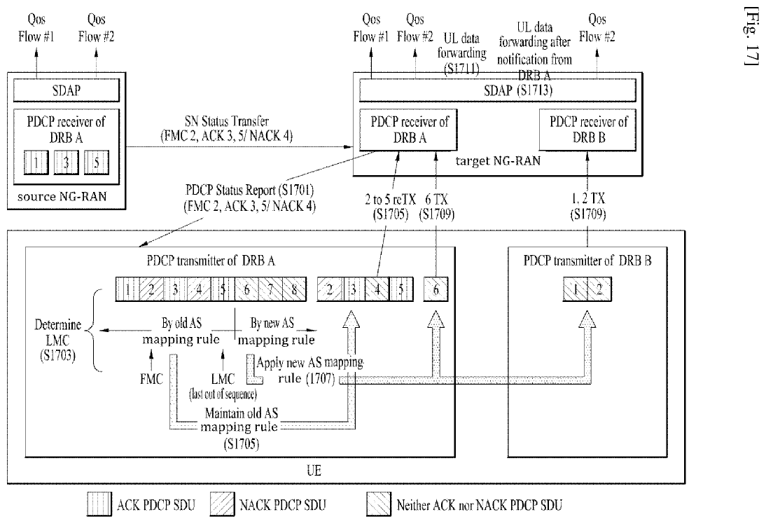

FIG. 16 is an example for transmitting lossless data packet based on QoS framework in wireless communication system according to embodiments of the present invention.

As shown in FIG. 16, when the Bitmap field is included in the PDCP status report (CASE #2), both UE and target NG-RAN use the PDCP status report in order to support lossless handover, as the followings:

The UE receives the PDCP status report from target NG-RAN (S1601).

The UE considers that the successful delivery of the PDCP SDUs (e.g., 1, 3 and 5), with the bit in the Bitmap field set to ‘1’, or with the associated COUNT value less than the COUNT value of the PDCP SDU identified by the FMC field has been confirmed. The UE defines LMC as the largest COUNT value (e.g., 5) of these ACK PDCP SDUs. Also, the UE confirms the unsuccessful delivery of the PDCP SDUs (e.g., 2 and 4) with the bit in the Bitmap field set to ‘0’ or identified by the FMC field (S1603).

The UE retransmits the NACK PDCP SDUs (e.g., 2 and 4) in ascending order of the COUNT values associated to the PDCP SDUs (S1605).

The UE remaps the PDCP SDUs (e.g., 6˜8), which have COUNT values larger than the LMC, to the DRB decided by the new AS mapping rule. In other words, PDCP SDU 7 for the QoS flow #1 is remapped to the DRB A, whereas PDCP SDU 6 and 8 for the QoS flow #2 are remapped to the DRB B. The UE associates new PDCP COUNTs with these PDCP SDUs (e.g., in case of DRB A, PDCP SDU 7->PDCP SDU 6, and in case of DRB B, PDCP SDU 6 and 8->PDCP SDU 1 and 2) (S1607).

The UE performs transmission of the PDCP SDUs with the newly associated COUNT value (S1609).

When receiving UL data for QoS flow #2 via DRB A, the target NG-RAN forwards the UL data without any waiting time (S1611)

When receiving UL data for QoS flow #2 via DRB B, the target NG-RAN buffers the received UL data until receiving notification from PDCP of the DRB A. Upon receiving the notification, the target NG-RAN starts forwarding the buffered UL data (S1613).

FIG. 17 is an example for transmitting lossless data packet based on QoS framework in wireless communication system according to embodiments of the present invention.

As shown in FIG. 17, when the Bitmap field is included in the PDCP status report (CASE #3), both UE and target NG-RAN use the PDCP status report in order to support lossless handover, as the followings:

The UE receives the PDCP status report from target NG-RAN (S1701).

The UE considers that the successful delivery of the PDCP SDUs (e.g., 1, 3 and 5), with the bit in the Bitmap field set to ‘1’, or with the associated COUNT value less than the COUNT value of the PDCP SDU identified by the FMC field has been confirmed. The UE defines LMC as the largest COUNT value (e.g., 5) of these ACK PDCP SDUs. Also, the UE confirms the unsuccessful delivery of the PDCP SDUs (e.g., 2 and 4) with the bit in the Bitmap field set to ‘0’ or identified by the FMC field (S1703).

The UE retransmits the PDCP SDUs from the first missing SDU up to the last out-of-sequence SDUs indicating in the PDCP status report (e.g., 2 to 5) in ascending order of the COUNT values associated to the PDCP SDUs (S1705).

The UE remaps the PDCP SDUs (e.g., 6˜8), which have COUNT values larger than the LMC, to the DRB decided by the new AS mapping rule. In other words, PDCP SDU 7 for the QoS flow #1 is remapped to the DRB A, whereas PDCP SDU 6 and 8 for the QoS flow #2 are remapped to the DRB B. The UE associates new PDCP COUNTs with these PDCP SDUs (e.g., in case of DRB A, PDCP SDU 7->PDCP SDU 6, and in case of DRB B, PDCP SDU 6 and 8->PDCP SDU 1 and 2 (S1707).

The UE performs transmission of the PDCP SDUs with the newly associated COUNT value (S1709).

When receiving UL data for QoS flow #2 via DRB A, the target NG-RAN forwards the UL data without any waiting time (S1711).

When receiving UL data for QoS flow #2 via DRB B, the target NG-RAN buffers the received UL data until receiving notification from PDCP of the DRB A. Upon receiving the notification, the target NG-RAN starts forwarding the buffered UL data (S1713).

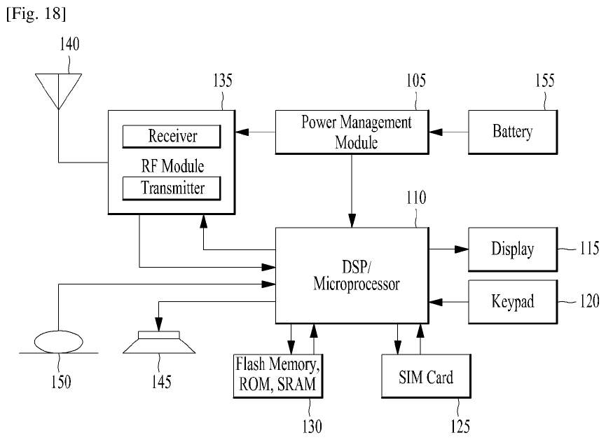

FIG. 18 is a block diagram of a communication apparatus according to an embodiment of the present invention.

The apparatus shown in FIG. 18 can be a user equipment (UE) and/or eNB adapted to perform the above mechanism, but it can be any apparatus for performing the same operation.

As shown in FIG. 18, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer's choice.

Specifically, FIG. 18 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 18 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

1. A method for a transmitter operating in a wireless communication system, the method comprising:
transmitting one or more Packet Data Convergence Protocol (PDCP) Service Data Units (SDUs) via a first data radio bearer (DRB) to a receiver;
determining whether each of the one or more PDCP SDUs is successfully transmitted or not on the first DRB, when a DRB mapped to a QoS flow is changed from the first DRB to a second DRB;
re-transmitting one or more first PDCP SDUs, which are determined to be not successfully transmitted on the first DRB, via the first DRB to the receiver; and
transmitting one or more second PDCP SDUs for the QoS flow, which have COUNT values higher than a highest COUNT value among COUNT values of the PDCP SDUs which are successfully transmitted on the first DRB, via the second DRB to the receiver.

2. The method according to claim 1, wherein the determining whether each of the one or more PDCP SDUs is successfully transmitted or not on the first DRB based on a PDCP status report received from the receiver, the PDCP status report indicating one or more PDCP SDUs are successfully transmitted or not on the first DRB.

3. The method according to claim 2, wherein if the PDCP status report include a first missing COUNT (FMC) field without bitmap information, the highest COUNT value is set to one less than a COUNT value indicated by the FMC field.

4. The method according to claim 1, wherein the determining whether each of the one or more PDCP SDUs is successfully transmitted or not on the first DRB based on a RRC message received from the receiver, the RRC message indicating one or more PDCP SDUs are successfully transmitted or not on the first DRB.
wherein the RRC message includes an identifier of the first DRB.

5. The method according to claim 1, further comprising:
releasing the first DRB when a timer is expired, wherein the timer starts after retransmitting one or more first PDCP SDUs.

6. The method according to claim 1, further comprising:
transmitting request of releasing the first DRB to the receiver, after re-transmitting one or more first PDCP SDUs;
releasing the first DRB when response corresponding to the request is received from the receiver.

7. The method according to claim 1, wherein when the one or more second PDCP SDUs are transmitted via the second DRB, the each of the one or more seconds PDCP SDUs is associated with a respective COUNT value available for the second DRB.

8. The method according to claim 1, wherein the one or more second PDCP SDUs transmitted via the second DRB are forwarded from a first PDCP entity of the first DRB to a second PDCP entity of the second DRB via a Service Data Adaptation Protocol (SDAP) entity associated with both of the first DRB and the second DRB,
wherein the SDAP entity of the transmitter is an a higher layer than the first PDCP entity and the second PDCP entity of the transmitter.

9. The method according to claim 8, wherein the SDAP entity submits one or more SDAP PDUs to the second PDCP entity of second DRB, after all of the second PDCP SDUs forwarded from the first PDCP entity of the first DRB are submitted to the second PDCP entity of second DRB.

10. A communication device for operating in a wireless communication system, the communication device comprising:
a Radio Frequency (RF) module; and
a processor operably coupled with the RF module and configured to:
transmit one or more Packet Data Convergence Protocol (PDCP) Service Data Units (SDUs) via a first data radio bearer (DRB) to a receiver;
determine whether each of the one or more PDCP SDUs is successfully transmitted or not on the first DRB, when a DRB mapped to a QoS flow is changed from the first DRB to a second DRB;
re-transmit one or more first PDCP SDUs, which are determined to be not successfully transmitted on the first DRB, via the first DRB to the receiver; and
transmit one or more second PDCP SDUs for the QoS flow, which have COUNT values higher than a highest COUNT value among COUNT values of the PDCP SDUs which are successfully transmitted on the first DRB, via the second DRB to the receiver.

11. The communication device according to claim 10, wherein the determining whether each of the one or more PDCP SDUs is successfully transmitted or not on the first DRB based on a PDCP status report received from the receiver, the PDCP status report indicating one or more PDCP SDUs are successfully transmitted or not on the first DRB.

12. The communication device according to claim 11, wherein if the PDCP status report include a first missing COUNT (FMC) field without bitmap information, the highest COUNT value is set to one less than a COUNT value indicated by the FMC field.

13. The communication device according to claim 10, wherein the determining whether each of the one or more PDCP SDUs is successfully transmitted or not on the first DRB based on a RRC message received from the receiver, the RRC message indicating one or more PDCP SDUs are successfully transmitted or not on the first DRB.
wherein the RRC message includes an identifier of the first DRB.

14. The communication device according to claim 10, further comprising:
releasing the first DRB when a timer is expired, wherein the timer starts after retransmitting one or more first PDCP SDUs.

15. The communication device according to claim 10, further comprising:
transmitting request of releasing the first DRB to the receiver, after re-transmitting one or more first PDCP SDUs;
releasing the first DRB when response corresponding to the request is received from the receiver.

16. The communication device according to claim 10, wherein when the one or more second PDCP SDUs are transmitted via the second DRB, the each of the one or more seconds PDCP SDUs is associated with a respective COUNT value available for the second DRB.

17. The communication device according to claim 10, wherein the one or more second PDCP SDUs transmitted via the second DRB are forwarded from a first PDCP entity of the first DRB to a second PDCP entity of the second DRB via a Service Data Adaptation Protocol (SDAP) entity associated with both of the first DRB and the second DRB,
wherein the SDAP entity of the transmitter is an a higher layer than the first PDCP entity and the second PDCP entity of the transmitter.

18. The communication device according to claim 17, wherein the SDAP entity submits one or more SDAP PDUs to the second PDCP entity of second DRB, after all of the second PDCP SDUs forwarded from the first PDCP entity of the first DRB are submitted to the second PDCP entity of second DRB.

19. The communication device according to claim 10, wherein the communication device is capable of communicating with at least one of another UE, a UE related to an autonomous driving vehicle, a base station and/or a network.
